(19) United States
(12) Patent Application Publication
(10) Pub. No.: US 2020/0074310 A1
(43) Pub. Date: Mar. 5, 2020

(54) REPORT GENERATION

(71) Applicant: ACCENTURE GLOBAL SOLUTIONS LIMITED, Dublin 4 (IE)

(72) Inventors: Chung-Sheng LI, San Jose, CA (US); Guruprasad DASAPPA, Bangalore (IN); Suraj Govind JADHAV, Navi Mumbai (IN); Manoj SHROFF, Bangalore (IN)

(73) Assignee: ACCENTURE GLOBAL SOLUTIONS LIMITED, Dublin 4 (IE)

(21) Appl. No.: 16/119,681

(22) Filed: Aug. 31, 2018

(51) Int. Cl. G06N 5/02; G06Q 40/00; G06F 17/27

(52) U.S. Cl. CPC G06N 5/02; G06F 17/2785; G06Q 40/12

(57) ABSTRACT

In an example, in response to occurrence of a report generation event, a report may be generated. An aspect of the report requiring a description may be identified, the aspect being at least one of a trend noted in the report and a discrepancy in the report. A hypothesis explaining the aspect of the report may be generated. Further, an evidence may be collected for the hypothesis, based on a relation between entities of the hypothesis, the relation being determined based on a knowledge data having information pertaining to the entities. The hypothesis may be evaluated generate an evaluation score, based on the collected evidence. Based on the evaluation score, the hypothesis may be selected for explaining the aspect. The selected hypothesis may be provided in natural language text explaining the aspect of the report, based on at least one of the domain and user knowledge and linguistic knowledge.

### BACKGROUND

Multiple processes are performed during corporate finance and accounting operations. The processes include data validation, data entry closing, data reconciliation, report generation, etc. For example, in corporate financing, reconciliation is performed between bank statements and cash accounts within a general ledger, between a ledger and a sub-ledger, between intercompany ledgers, and between multiple Enterprise Resource Planning (ERP) systems. Likewise, in various organizations, the report generation may be performed, for instance, for financial reporting of items, such as non-reconciled items from bank-and-cash, intercompany, ledger-to-subledger reconciliation), budget vs. actual, etc.

Reporting may be performed for a variety of purposes, for instance, for management purposes or financial purposes, which may be internal to an organization, such as revenue of a department or external, such as quarter end statements. Report generation is generally performed at the close of a reporting period, which is generally at the end of the month or the end of the quarter. As a result, if data is required prior to reporting period, it may not be available and any course correction that could have been done at an early stage may not be done till the period end.

Such reporting are often generated manually from spreadsheets, which are compiled/extracted from multiple ERP and data warehouse systems. Not only the manual resource may need to do repetitive work, the report generation may also be less than timely and may lack the up-to-the-moment information. Such report generation is not only prone to error, is time consuming, and complex but may also fail to provide insight to various aspects of the report, while only focusing on facts or numbers. Such a report may not be useful for all the consumers, for instance, a manager may not appreciate just the sales figures for a quarter without supplementary information regarding the sales.

This presents a technical problem of devising a report generation mechanism that may efficiently generate reports continuously or on demand with required accuracy and with information describing the facts included in the report in a resource efficient manner.

### BRIEF DESCRIPTION OF DRAWINGS

Features of the present disclosure are illustrated by way of examples shown in the following figures. In the following figures, like numerals indicate like elements, in which:

FIG. 1 illustrates a block diagram of a report generation system, according to an example embodiment of the present disclosure;

FIG. 2 illustrates an example process for report generation performed by the report generation system, according to an example embodiment of the present disclosure;

FIG. 3 illustrates an example process of a management report analysis, according to an example embodiment of the present disclosure;

FIG. 4 illustrates an example process of hypothesis generation, according to an example embodiment of the present disclosure;

FIG. 5 illustrates an example process of evidence generation, according to an example embodiment of the present disclosure;

FIG. 6 illustrates an example process of recommendation generation, according to an example embodiment of the present disclosure;

FIG. 7 illustrates a schematic of narrative synthesizing process, according to an example embodiment of the present disclosure;

FIG. 8 illustrates an example of management report generated by the report generation system, according to an example embodiment of the present disclosure;

FIG. 9 illustrates a hardware platform for implementation of the validation system, according to an example embodiment of the present disclosure; and

FIG. 10 illustrates a computer-implemented method for report generation and synthesis of associated data, according to an example embodiment of the present disclosure.

### DETAILED DESCRIPTION

For simplicity and illustrative purposes, the present disclosure is described by referring mainly to examples thereof. The examples of the present zo disclosure described herein may be used together in different combinations. In the following description, details are set forth in order to provide an understanding of the present disclosure. It will be readily apparent however, that the present disclosure may be practiced without limitation to all these details. Also, throughout the present disclosure, the terms “a” and “an” are intended to denote at least one of a particular element. As used herein, the term “includes” means includes but not limited to, the term “including” means including but not limited to. The term “based on” means based at least in part on.

The present disclosure describes systems and methods for continuous generation of reports, such as financial reports and management reports data in an organization. The financial report may be used by external consumers, such as banks, investors, and government regulators, while the management reports may primarily be for internal consumers, such as managers, owners, partners, etc.

These reports may be generated on demand or occurrence of an accounting event, collectively referred to as, a report generation event. An accounting event may be set by a set of predefined triggering conditions so that a report is synthesized for a given stakeholder as soon as the triggering condition is met. Alternatively, the report may be generated on demand, when a stakeholder requests. The present disclosure provides for such continuous generation of reports in an accurate, and time and resource efficient manner with minimum intervention by an external agent, such as, a human resource.

In an example, on occurrence of a report generation event, a report may zo be generated using data from one or more data sources. The report generation event may be for instance, end of a reporting period, end of a pre-defined report generation period, or an input provided by a stakeholder to generate the report. The report may be, for instance, a financial report and a managerial report. The financial report may include profit and loss statement, balance sheet, accounts payable, accounts receivable, statement of cash flows, etc. the managerial report may include profit and loss by class, department, team, job, realization rate, utilization rate, etc.

Upon generation of the report, the report may be synthesized, for instance various recommendations, explanations regarding aspects of the report may be provided. An aspect of the report may be a feature derived on comparing with other reports/data sources. The aspect may be, for instance, a trend or a discrepancy in the report. In an example, such aspect(s) of the report may be identified in a data analysis phase. For the identified aspect, one or more hypothesis explaining the aspect of the report may be generated using one or more of abductive reasoning, deductive reasoning, and inductive reasoning. The hypothesis may also include a remedial action to correct the aspect, if required. For each of the hypothesis, an evidence may be collected, based on a relation between entities of the hypothesis. The relation is determined based on a knowledge database having information pertaining to the entities. For instance, in case of a discrepancy between budget and actual, the evidence may be source data, such as a spreadsheet or a database, which was used to generate the budget and the actual. The relationships may be predefined in the knowledge database. The evidence may be indicative of facts used generating the report.

Based on the collected evidence, an evaluation score is generated for each of the hypothesis. Further, based on the collected evidence, a hypothesis is selected for explaining the aspect. For instance, a hypothesis with highest score or hypothesis with a score greater than a threshold may be selected. To provide a narrative of the aspect, a narrative corresponding to the selected hypothesis is provided in natural language text, based on at least one of the domain and user knowledge and linguistic knowledge and associated with the report.

Thus, the report may be automatically generated as soon as the reporting ends. Alternatively, the report generation may be performed at time configured by a user, such as end of day, instead of waiting till end of reporting period or on demand. Thus, the present system offers the flexibility of performing report generation in real-time or later, to provide the report, when desired.

Further, the present disclosure provides for explaining aspects of the report, thereby associating meaning with the numbers, thereby not only making it simpler for the users to analyze the report but also adding information, which otherwise was not available. Also, owing to automated generation and analysis the errors may be substantially reduced, the computational resources may be better utilized owing to minimization of rework and reprocessing.

Thus, the present disclosure provides a comprehensive system for report zo generation in a time and resource efficient manner. The present disclosure offers a tool that is flexible yet capable of handling complex report generation and synthesis process. Thus, the present disclosure provides a comprehensive, flexible, economic, and time-effective approach for report generation.

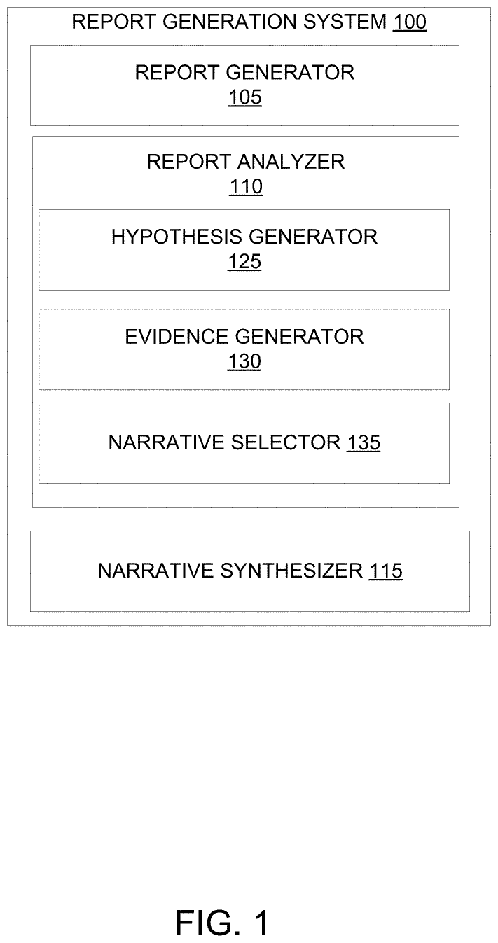

FIG. 1 illustrates a report generation system 100 for generating reports associated with an organization, according to an example embodiment of the present disclosure. In an example embodiment, the validation system 100, hereinafter referred to as system 100, uses a combination of Artificial Intelligence (AI), machine learning techniques, and natural language processing (NLP) techniques to perform a variety of operations associated with report generation.

In an example, the system 100, amongst other components, includes a report generator 105, a report analyzer 110, and a narrative synthesizer 115. The system 100 provides for continuous generation of reports. The reports may include reports generated as per objects and purpose (internal reports and external reports (profit&loss/balance sheet)), reports generated as per nature (enterprise, investigating, and control), reports generated as per nature (routine and special), and reports generated as per functions (operating/managerial and financial).

Further, reports may be generated to provide insights pertaining various organizational operations, for instance, control reports may provide insights to bonded (i.e. insured) cash-handling employees, dual-signature requirements on all checks over a pre-defined amount such as $1,000, employee background checks, employee training and required certifications, password protected access to asset storage areas, physical locks on inventory warehouses, security camera systems, segregation of duties (Links to an external site.)Links to an external site (i.e. recording, authorization, and custody all handled by separate individuals, bank reconciliations (i.e. cash per the bank is reconciled to the cash per the company's books), control totals (i.e. cash per cash register tape is reconciled to cash received in the cash register bag), physical inventory counts (i.e. inventory is physically counted and then compared to the inventory ledger), reconciliation of the general ledgers to the detailed subsidiary ledgers(Links to an external site.)Links to an external site, surprise counts of cash on hand (i.e. petty cash is counted on a random and surprise basis), data backups for restoring lost data in case of a fire or other disaster, data validity tests requiring users to confirm data inputs if amounts are outside a reasonable range, using insurance to help replace damaged or stolen assets, management variance reports highlighting variances from budget to actual for management corrective action, and training and operations manuals can be revised to prevent future errors and irregularities.

In an example, the report generator 105 may determine if a report generation event has occurred. The report generation event may be based on occurrence of an accounting event, such as end of reporting period, predefined period, or a request by a user to generate the report. For instance, a quarterly sales report may be generated automatically when a quarter ends or a leave record of employees in a department may be generated on receiving an input from a zo stakeholder

In an example, the report generator 105 may also determine a type of report, such as financial or managerial. The financial reports may be for external stakeholders, such as banks, regulators, and investors. Further, the financial reports may be mandatory and may have to adhere standard guidelines issued by various regulators. The financial reports may show company's overall performance at a given time. The financial reports may also refer to previous reports to indicate how the company performed. The managerial reports may be generated for internal stakeholders, such as CEOs and managers. Unlike financial reports, the managerial reports may not have adhere to standards and guidelines by regulators. The managerial reports may be segments as per requirement, such as department, unit, etc. The managerial reports may aid in making decisions regarding future.

Upon determining the type of report, a corresponding report may be generated. The type of the report may be determined based on the report generation event. The report generator 105 may gather data from one or more data sources 120, which may be internal or external to the organization. In an example, in case of a financial report, the report may be generated as per predefined rules and standards set by a corresponding regulatory.

The report, such as financial report, may be indicative of objective, i.e., may provide explain why the report is generated. For instance, the report may provide information about the reporting entity that is useful to present and potential investors, lenders, and other creditors in their capacity as capital providers. The zo report may provide details pertaining to qualitative characteristics, such as fundamental qualities and enhancing qualities; and elements, such as assets, liabilities, equity, income, and expenses. Further, certain assumptions may be made, such as economic entity, going concern, monetary unit, periodicity, and accrual. The report may be based on certain principals, such as measurement, revenue recognition, expense recognition, and full disclosure; and constraints, such as costs.

A report usually has a predefined set of objectives (financial statements, comparison between actual and budget, analysis of discrepancy) and may be targeted for a specific audience (SEC, investors, management within the firm). The report generator 105 may generate the report by collecting information and data relevant for the report generation from a data source, which may be internal or external to the system 100, for instance, a database, a web survey, a spreadsheet, or any other source of data. Further, data model transformation, data cleansing and/or data normalization may be performed to ensure the data in the report is comparable for subsequent report analysis.

The generated may be synthesized by the report analyzer 110 and the narrative synthesizer 115. In an example, the report analyzer 110 may include a hypothesis generator 125, an evidence generator 130, and a narrative selector 135. Based on then type of the report, the data analyzer 110 may analyze the report to generate a recommendation pertaining to aspect of the report. An aspect of the report may be report element/component that may require explanation. For instance, a trend noted in the report or a discrepancy. Adding such explanations to the aspect, provides meaning to numbers/facts recorded in the report.

To analyze, the hypothesis generator 125 of the report analyzer 110 may identify an aspect of the report, which need an explanation. Upon identification of the aspect, one or more hypothesis explaining the aspect may be generated. The hypothesis may provide a possible explanation for the trend or discrepancy in the report and a remedial action to rectify the discrepancy or change the trend (if required) may be generated. The hypothesis may be generated using reasoning techniques, such as abductive reasoning, deductive reasoning, and induction reasoning techniques.

For instance, the abductive reasoning techniques may implement evidence based reasoning techniques, for providing the hypothesis and the explanatory evidence. The abductive reasoning can be understood as a form of logical inference that proceeds from an observation to a hypothesis that accounts for the observation and, in the process, seeks to find the simplest and most likely explanation. In abductive reasoning, unlike in deductive reasoning, such as backward or forward chaining, the premise does not guarantee the conclusion. Therefore, abductive reasoning can be understood as “an inference to the best explanation”. Based on the type of report, one or more of the reasoning techniques may be implemented.

Upon generating the hypothesis, the evidence generator 130 may collect zo evidences pertaining to of the generated hypothesis. Evidence collection may involve extraction of entities and the relation between them and their comparison against a knowledge base. The knowledge base may include details pertaining to entities in various reports and relation there between.

The narrative selector 135 may select a hypothesis most likely to explain the aspect, based on the collected evidence. The narrative selector 135 may compute an evaluation score corresponding to each hypothesis, based on the collected evidence. In an example, the evaluation score is determined based on the combination of priori probability that the hypothesis is true and the maximum likelihood based on the available evidence, to form the posteriori probability of the hypothesis using Bayes theorem.

Based on the evaluation score, a hypothesis may be selected to provide a narrative to the aspect of the report. For instance, the hypothesis with highest score or score greater than a threshold may be selected. Alternatively, assistance from an external agent may be requested. In case external assistance is requested, the external agent's input may be gathered by a feedback based self learner (not shown in figures) to update the report analyzer 110.

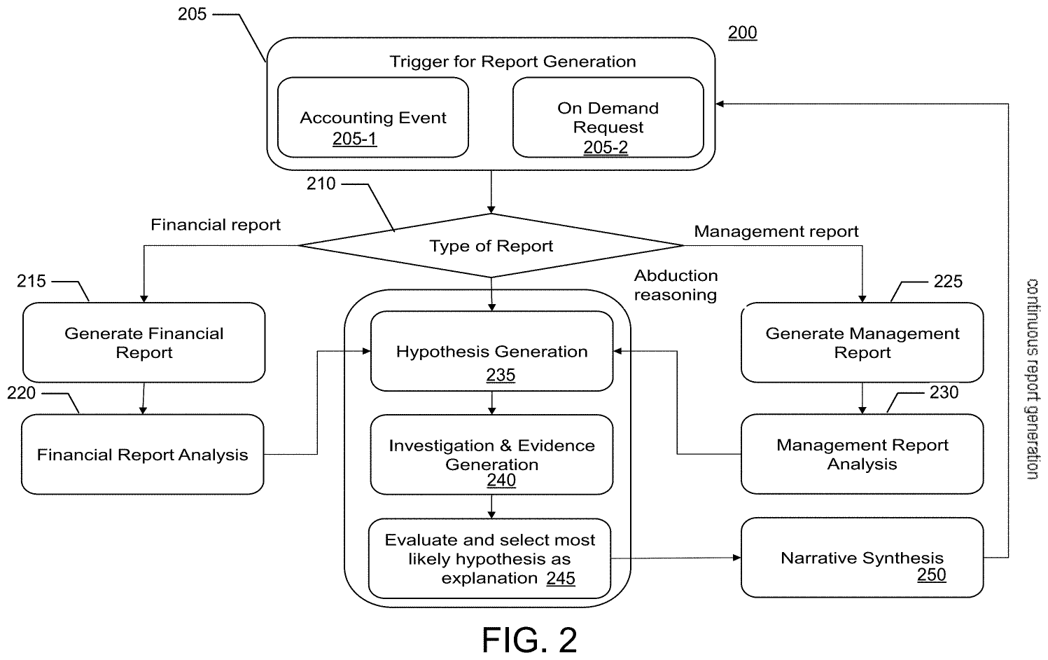

The report analyzer 110 may provide for autonomous investigation and interpretation. The investigation, as described above, may include the use of external data within the institution/organization or publicly available on the internet. As an example, to explain that a certain portion of the business is not performing well relative to the competition, automatic investigation can be launched on social media as well as publicly available report to conclude whether it is due to more effective campaign by the completion, or due to inferior reaction to the product by the customers. The report analysis with respect to types of report is explained in detail with respect to description of FIGS. 2-6.

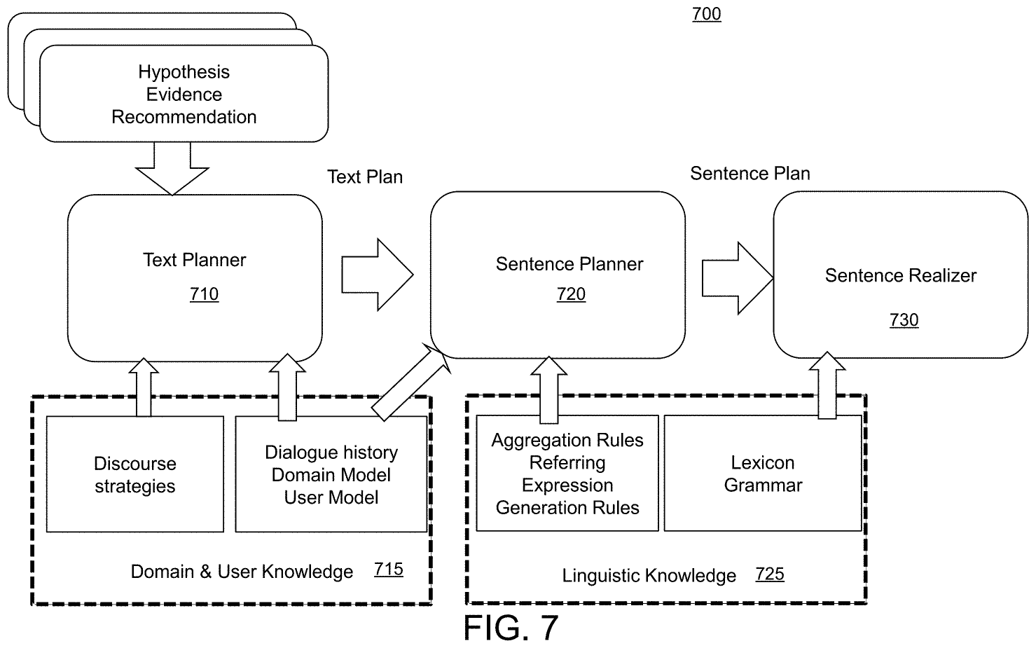

The narrative corresponding to selected hypothesis explaining the aspect of the report, may be synthesized by the narrative synthesizer 115. The narrative synthesizer 115 by using natural language generation technique, may obtain pertinent value from the spreadsheet or database or data warehouse (including NoSQL database) and integrate into pre-configured sentence and paragraph corresponding to explanation indicated by the hypothesis. These sentences can be further personalized based on user requirements. The details pertaining to the narrative synthesis are provided with reference to description of FIG. 7.

Thus, the present disclosure provides for continuous generation of reports, where the reports are synthesized to provide meaningful information regarding various aspects of the report. For instance, since, a report may need to account for the trend or discrepancy between budget and actual and may need to drill down on the contributors to the difference and report the top contributors, the report synthetization as described herein provides such information. For instance, why employees of a certain department are overworking as well as taking leaves higher than a threshold.

FIG. 2 schematically illustrates a report generation and synthetization zo process 200, according to an example embodiment of the present disclosure. At block 205, a trigger of report generation is received. As mentioned earlier, the trigger may be an accounting event 205-1 or on demand request 205-2. At block 210, the type of the report may be determined and the process 200 proceeds accordingly. The type of the report, in an example, may be financial or managerial.

When the report is financial, a financial report is generated at 215 and report is analyzed at 220. Likewise, at block 225, a managerial report is generated and at block 230, the managerial report is analyzed. The report may be generated by the report generator 105 and the report may be analyzed by the report analyzer 110.

The analysis of the report involves hypothesis generation 235 using a reasoning technique, investigation and evidence generation 240, and evaluation and selection of a hypothesis as a probable explanation. Subsequently, based on the analysis, a hypothesis may be selected at block 245, based on likelihood of the hypothesis explaining the aspect, followed by a narrative synthesis may be performed at block 250, where the narrative may be provided in natural language text.

Referring to financial report generation, in an example, the financial report may generated adjusted trial balance from sources, such as, income statement, retained earning statement, and balance sheet. The financial statement analysis may involve characteristics, such as liquidity, profitability, and solvency and comparison basis, such as intracompany, industry averages, and intercompany. Further, the financial statement analysis may use tools, such as horizontal analysis, vertical analysis, or ratio analysis.

The horizontal analysis may include trend analysis, which is a technique for evaluating a series of financial statement data over a period of time. This may be performed to determine increase or decrease in an attribute. The horizontal analysis may be applied to the balance sheet, income statement, and statement of retained earnings.

The vertical analysis is also referred to as common-size analysis, which is a technique that expresses each financial statement item as a percent of a base amount. For instance, on an income statement, it may be stated that selling expenses are 16% of net sales. The vertical analysis may be applied to the balance sheet and income statement.

The ratio analysis expresses the relationship among selected items of financial statement data. The ratio classifications may include liquidity-for measuring short-term ability of the company to pay its maturing obligations and to meet unexpected needs for cash; profitability-for measuring the income or operating success of a company for a given period of time; and solvency—for measuring the ability of the company to survive over a long period of time.

The financial report analysis tools may provide, for instance, trends. Such trends may then be validated or explained using hypothesis as explained above. Thus, the financial report analysis may involve various tools for determining a possible explanation of an aspect. The managerial report analysis is explained in subsequent figures.

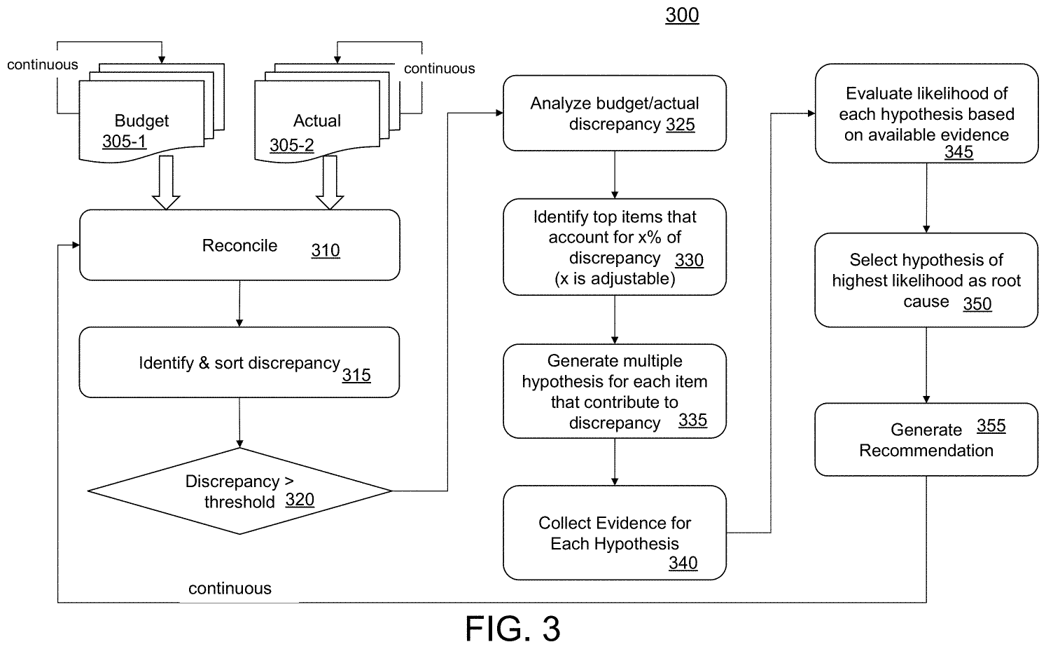

FIG. 3 schematically illustrates a managerial report generation and analysis process 300, according to an example embodiment of the present disclosure. At onset, budget and actuals may be continuously collected at 305-1 and 305-2, respectively. At block 310, data corresponding to budget and data corresponding to actual may be reconciled. For instance, it may be checked whether the data gathered from budget matches with the actuals. At block 315, discrepancies may be identified and sorted. For instance, when two item lists may be compared (say budget vs. actual), it is unlikely that the lists are identical. The difference of each individual item on the item list may be sorted based on the discrepancy. Thus, the sorting may be performed based on the discrepancy between two item lists (either between budget or actual, or between two time instants)

At block 320, it is ascertained whether the discrepancies are greater than a threshold. When the discrepancies are greater than a threshold, budget/actual discrepancy is analyzed further at block 325. The analysis may be performed recursively until a predefined set of discrepancies or trend are explained by hypothesis during report analysis. For instance, major trends and discrepancies (aspects) may be predefined and these trends and discrepancies may be analyzed. The analysis may involve, for instance, when analyzing trends, the rate of change and when analyzing discrepancies, major factors may be explained. In an example, in cases where the trend or discrepancy cannot be explained, then the data is recursively decomposed until the underlying trend or discrepancy can be fully explained. Based on the analysis, at block 330, top items that account for predefined percentage/share of discrepancy may be identified.

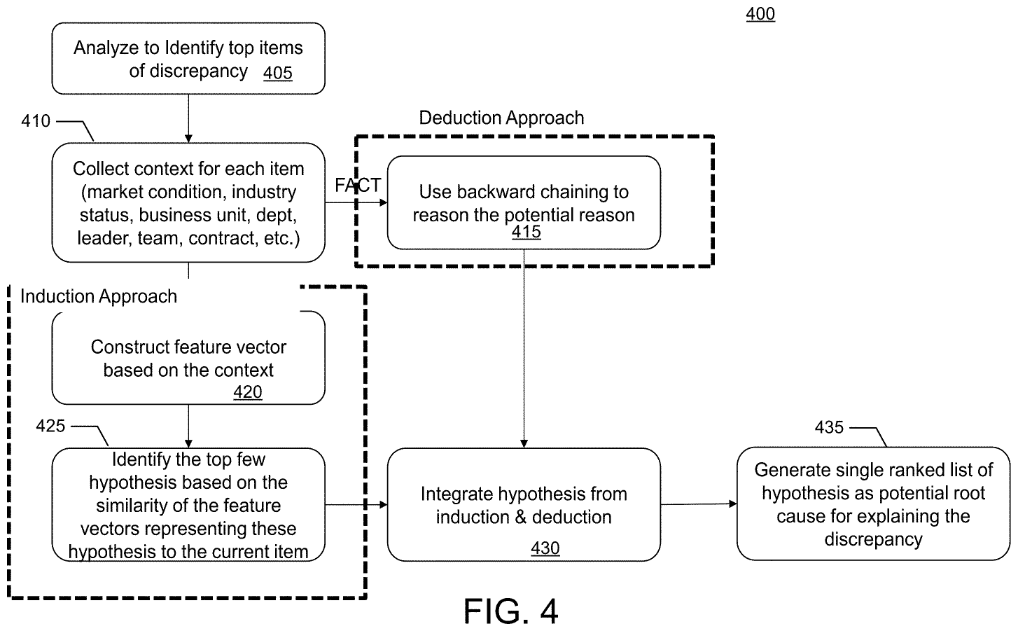

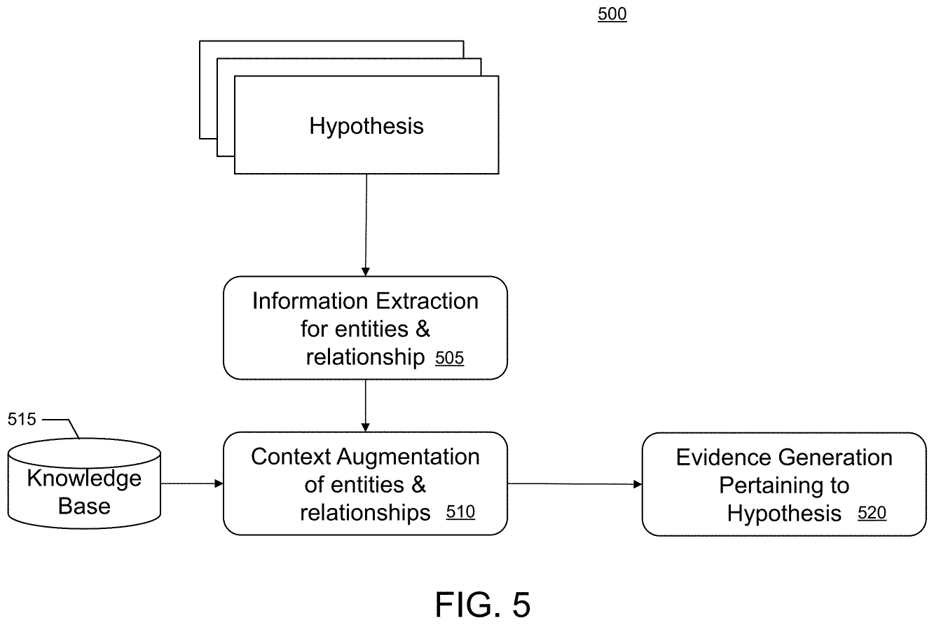

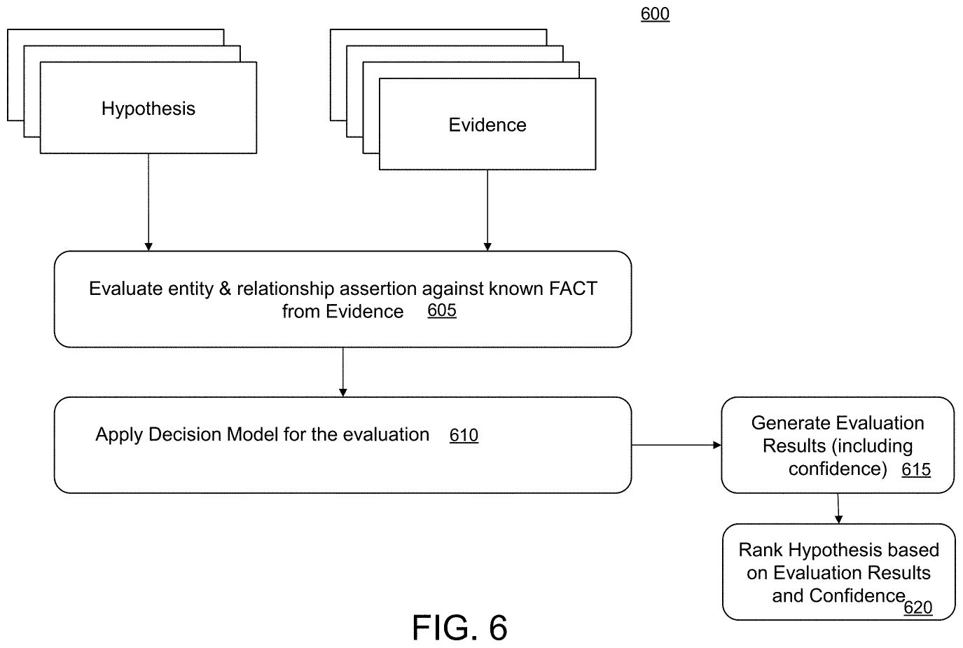

At block 335, multiple hypothesis for each item that contribute to discrepancy may be determined as will be explained in detail with reference to description of FIG. 4. At block 340, evidence for each hypothesis may be collected as will be explained with reference to FIG. 5. At block 345, a likelihood (evaluation score) of each hypothesis based on available evidence may be evaluated, which explained further with reference to description of FIG. 6. At block 350, hypothesis of highest likelihood or evaluation score may be selected as root cause. Finally, at block 355, a recommendation or a narrative may be generated, based on the selected hypothesis.

FIG. 4 schematically illustrates hypothesis generation process 400 for discrepancy between budget and actuals, according to an example embodiment of the present subject matter. In an example, the process 400 may be implemented by the data analyzer 110. The process 400 may proceed with analysis of discrepancy to identify top contributors at block 405. At block 410, context for each item (market condition, industry status, business unit, department, leader, team, contract, etc.) may be collected. Based on the facts from 410 and using deductive reasoning, backward chaining may be performed to reason the potential reason, at zo block 415. At block 420, using inductive reasoning, feature vector may be constructed based on the context. At block 425, the top few hypothesis based on the similarity of the feature vectors representing these hypothesis to the current item may be identified.

At block 430, hypothesis from induction & deduction may be integrated. At block 435, a single ranked list of hypothesis as potential root cause for explaining the discrepancy may be generated. These hypothesis may be evaluated based on corresponding evidence to select a hypothesis for explaining the aspect of the report.

FIG. 5 schematically illustrates evidence collection process 500, according to an example embodiment of the present disclosure. In an example, the process 500 may be implemented by the data analyzer 110. At block 505, hypothesis is received as an input and information is extracted from the hypothesis to obtain entities and relation between the entities. At block 510, context augmentation of entities and relationships may be performed, using a knowledge base 515, evidence pertaining to the hypothesis may be generated at block 520. Context augmentation may be performed to augment the entities and relationship with one or more of: its basic definition, related concepts that can be found on, for example, through knowledge graph, Internet search, or within a master database, and related trending.

FIG. 6 schematically illustrates a narrative (recommendation) generation zo process 600, according to example embodiment of the present disclosure. In an example, the process 600 may be implemented by the data analyzer 110. At block 605, a hypothesis and a corresponding evidence may be received as an input to evaluate entity and relationship assertion (from hypothesis) against known fact from the evidence. At block 610, a decision model, such as Bayesian Decision Model may be applied for the evaluation. At block 615, evaluation results (including confidence) may be generated. At block 620, hypothesis may be ranked based on evaluation results and confidence/evaluation score. Further, based on the ranking and evaluation score, a hypothesis may be selected as a narrative for the discrepancy.

FIG. 7 schematically illustrates narrative synthesis process 700 for report generation, according to an example aspect of the present disclosure. In an example, the process 700 may be implemented by the narrative synthesizer 115. At block 705, selected narrative/recommendation, based on the selected hypothesis. Upon receiving the narrative, a text planner 710 may perform content selection and discourse planning, using domain and user knowledge base 715. The domain and user knowledge base 715 may include discourse strategies and dialog history, domain model and user model.

Output from the text planner 710, which may be a text plan, may be provided to a sentence planner 720, which may perform aggregation, referring expression generator, and lexical choice, using domain and user knowledge and linguistic knowledge base 725. The linguistic knowledge base 725 may include aggregation rules, referring expression, generation rules, and lexicon grammar. In an example, the text planner, based on the intent and goal of the communication, may assemble the relevant pieces of the communication in terms of description of the trend or discrepancy, description of the analysis (could include the analysis approach), description of the explanation, and description of the recommendation. Such assembling process may be referred to as aggregation. The exact sentence may be specialized based on the audience to determine whether specific terminology, acronym, and other terminologies is to be used. In other examples, other features such as tone may also be adjusted based on the audience.

Output from the sentence planner, i.e., a sentence plan, may be provided to a sentence realizer 730, which may use the linguistic knowledge base to provide the narrative in natural language text. Further, the narrative may be associated with the report. The narrative in addition to causes may also include a remedial action/recommendation.

Generally, report generation relies heavily on the use of templates. The present subject matter determines intent of the report, and the intent may then be used to drive the assembly of the relevant trending, discrepancy analysis, and explanation, and potentially the recommendations. All these may considered as goals of the report. For instance, consider report generated for a sales team. The sales team may be analyzed by sales in the region in terms of the target vs. actual in terms of monthly, quarter to date, and year to date. Further, mitigating factors in terms of the macro and micro environment of the market may also be included. The sales team may be ranked based on the percentage of competition against the target. The discrepancy of each member of the team (delayed signing, deal fell through, insufficient lead generation, renewal fell through, etc., may also be explained. Finally, a recommendation for each sales team member may be generated based on the explanation.

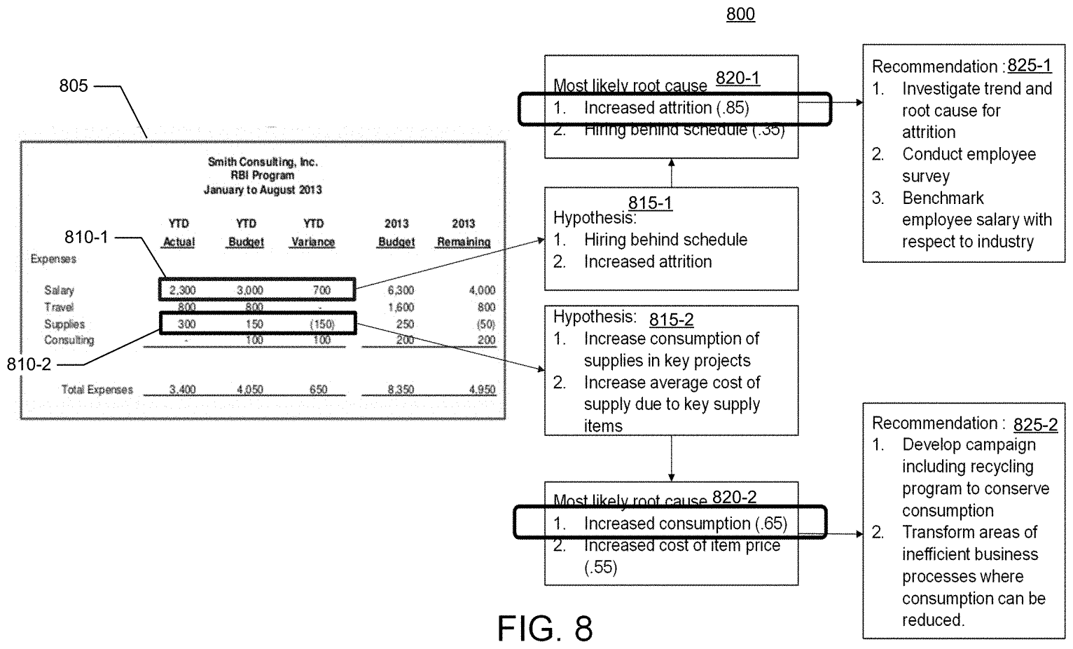

FIG. 8 illustrates an example of report synthesis 800 generated by the system 100, according to an example embodiment of the present disclosure. As can be seen, a management report 805 is generated. The report includes various expenses, such as salary, travel, supplies, and consulting and actual-budget comparison. A variance may be observed in salary and supplies as indicated by 810-1 and 810-2. Further, hypothesis 815-1 may be generated for salary related aspect and hypothesis 815-2 may be generated for supplies related aspect. The hypothesis 815-1 includes two causes for aspect (trend/discrepancy): hiring behind schedule and increased attrition; and the hypothesis 815-2 also includes two causes: increase consumption of supplies in key projects and increase average cost of supply due to key supply items.

Based on evidence collection and evaluation, most probable root cause may be identified. For salary related aspect, increased attrition with score of 0.85 may be selected as the probable root cause at 820-1, while for supplies, increased consumption with evaluation score of 0.65 may selected as root cause at 820-2. The hypothesis corresponding to the identified root cause is selected for explaining the aspect. Based on the selected hypothesis, recommendation may be provided and associated with the report 805. The recommendation(s) 825-1 for salary may include investigating trend and root cause for attrition, conduct employee survey, and benchmark employee salary with respect to industry. Likewise, the recommendation(s) 825-2 for salary may include developing campaign including recycling program to conserve consumption and transforming areas of inefficient business processes where consumption can be reduced.

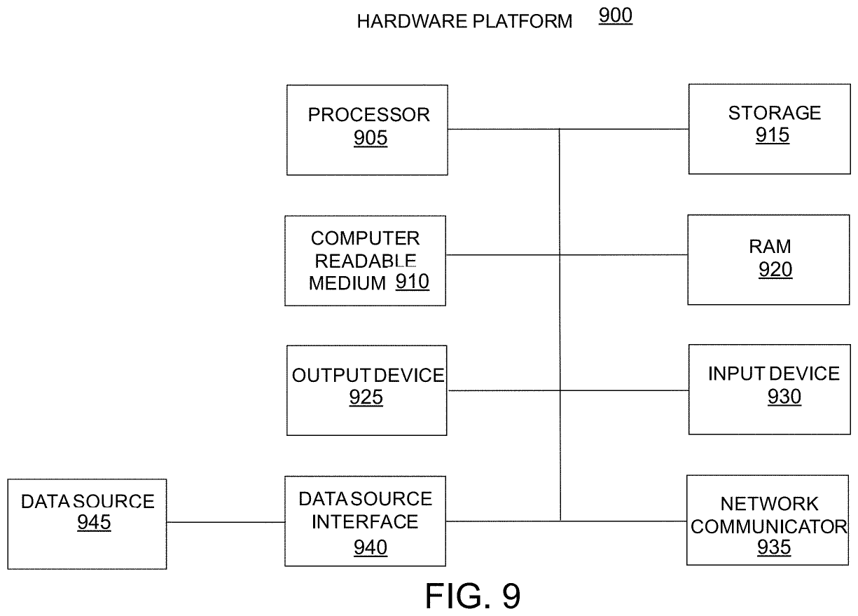

FIG. 9 illustrates a hardware platform 900 for implementation of the system 900, according to an example of the present disclosure. In an example embodiment, the hardware platform 900 may be a computer system 900 that may be used with the examples described herein. The computer system 900 may represent a computational platform that includes components that may be in a server or another computer system. The computer system 900 may execute, by a processor (e.g., a single or multiple processors) or other hardware processing circuit, the methods, functions and other processes described herein. These methods, functions and other processes may be embodied as machine readable instructions stored on a computer readable medium, which may be non-transitory, such as hardware storage devices (e.g., RAM (random access memory), ROM (read only memory), EPROM (erasable, programmable ROM), EEPROM (electrically erasable, programmable ROM), hard drives, and flash memory). The computer system 900 may include a processor 905 that executes software instructions or code stored on a non-transitory computer readable storage medium 910 to perform methods of the present disclosure. The software code includes, for example, instructions to obtain data, reconcile data, generate confidence score, and perform summarization. In an embodiment, the report generator 105, the report analyzer 110, and the narrative synthesizer 115 are a software code or a component performing the above steps.

The instructions on the computer readable storage medium 910 are read and stored the instructions in storage 915 or in random access memory (RAM) 920. The storage 915 provides a large space for keeping static data where at least some instructions could be stored for later execution. The stored instructions may be further compiled to generate other representations of the instructions and dynamically stored in the RAM 920. The processor 905 reads instructions from the RAM 920 and performs actions as instructed.

The computer system 900 further includes an output device 925 to provide at least some of the results of the execution as output including, but not limited to, visual information to users, such as external agents. The output device can include a display on computing devices. For example, the display can be a mobile phone screen or a laptop screen. GUIs and/or text are presented as an output on the display screen. The computer system 900 further includes input device 930 to provide a user or another device with mechanisms for entering data and/or otherwise interact with the computer system 900. The input device may include, for example, a keyboard, a keypad, a mouse, or a touchscreen. In an embodiment, output of the intelligent risk management agent is displayed on the zo output device 925. Each of these output devices 925 and input devices 930 could be joined by one or more additional peripherals.

A network communicator 935 may be provided to connect the computer system 900 to a network and in turn to other devices connected to the network including other clients, servers, data stores, and interfaces, for instance. A network communicator 935 may include, for example, a network adapter such as a LAN adapter or a wireless adapter. The computer system 900 includes a data source interface 940 to access data source 945.

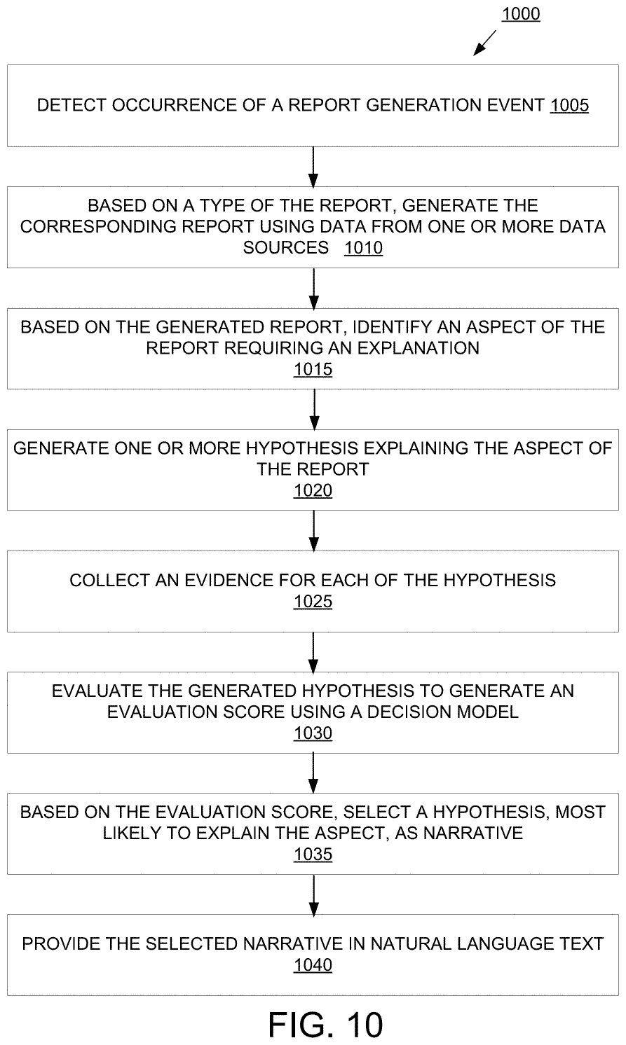

FIG. 10 illustrates a computer-implemented method 1000 depicting functionality of the system 100, according to an example embodiment of the present disclosure. For the sake of brevity, construction and operational features of the system 100 which are explained in detail in the description of FIG. 1-FIG. 9 are not explained in detail in the description of FIG. 10.

At method block 1005, the method 600 commences by detecting occurrence of a report generation event. The report generation event may be, for instance, an accounting event, such as end of a reporting period; and a request from a user to provide a report.

At block 1010, based on a type of the report, the corresponding report may be generated using data from one or more data sources. The report may be, for instance, a financial report or a managerial report. In an example, the report generator 105 may generate the report, on occurrence of the report generation zo event.

At block 1015, based on the generated report, an aspect of the report requiring an explanation may be identified. The aspect may be a component requiring further explanation, such as a trend noted in the report (increase in sales of a particular product, decrease in employee participation in training, etc.) or a discrepancy (budget-actual variance).

At block 1020, one or more hypothesis explaining the aspect of the report may be generated. The hypothesis may be generated using inference based reasoning techniques, such as abductive reasoning and deductive reasoning. In an example, in case of financial report generation, at least one of vertical, horizontal, and ratio analysis may be performed to provide rending. The trending may be followed by explanation by way of hypothesis generation, which in turn may be followed by reasoning techniques. In an example, the data analyzer 110 may identify the aspect and generate hypothesis.

At block 1025, an evidence may be collected for each of the hypothesis, based on entities of the hypothesis and relationship between these entities.

At block 1030, the generated hypothesis may be evaluated to generate an evaluation score using a decision model, such as Bayesian decision model. The valuation may be performed based on entities of the hypothesis and relationship between these entities; and facts provided by the corresponding evidence.

At block 1035, based on the evaluation score, a hypothesis most likely to explain the aspect may be selected as narrative, i.e., as an explanation of the zo aspect. The hypothesis may also include recommendations. In an example, the hypothesis generation and narrative generation may be performed by the report analyzer 110.

At block 1040, the selected narrative may be provided in natural language text and associated with the report. The narrative in natural language text may be generated using natural language processing techniques and databases, such as domain and user knowledge; and linguistic knowledge. In an example, the narrative may provide the cause and the remedial action.

What has been described and illustrated herein are examples of the present disclosure. The terms, descriptions and figures used herein are set forth by way of illustration only and are not meant as limitations. Many variations are possible within the spirit and scope of the disclosure, which is intended to be defined by the following claims and their equivalents in which all terms are meant in their broadest reasonable sense unless otherwise indicated.

What is claimed is:

1. A report generation system comprising:
a processor;
a report generator coupled to the processor to generate a report, in response to occurrence of a report generation event;
a report analyzer coupled to the processor to,
identify an aspect of the report requiring a description, the aspect being at least one of a trend noted in the report and a discrepancy in the report;
generate a hypothesis explaining the aspect of the report, using at least one of an abductive reasoning, deductive reasoning, and inductive reasoning;
collect an evidence for the hypothesis, based on a relation between entities of the hypothesis, the relation being determined based on a knowledge data having information pertaining to the entities;
evaluate the hypothesis to generate an evaluation score, based on the collected evidence; and
select the hypothesis for explaining the aspect, based on the evaluation score; and
a narrative synthesizer coupled to the processor to,
provide the selected hypothesis in natural language text explaining the aspect of the report, based on at least one of the domain and user knowledge and linguistic knowledge; and
associate the narrative with the aspect of the report.

2. The system as claimed in claim 1, wherein the report generator is to determine a type of the report, and wherein the report is generated, based on the determined type.

3. The system of claim 1, wherein the report analyzer is to perform context augmentation of entities and relationship between the entities of the hypothesis to collect the evidence.

4. The system as claimed in claim 1, wherein the narrative synthesizer comprises:
a text planner to generate a text plan for the selected hypothesis, based on the domain and the user knowledge;
a sentence planner to generate a sentence plan, based on the text plan, using at least one of the domain and the user knowledge and the linguistic knowledge; and
a sentence realizer to generate the narrative in the natural language text, based on the sentence plan, using at least one of the domain and the user knowledge and the linguistic knowledge.

5. The system as claimed in claim 1, wherein the report analyzer is to implement a financial statement analysis tool to determine the aspect, the financial statement analysis tool being one of a horizontal analysis tool, a vertical analysis tool, and a ratio analysis tool.

6. The system as claimed in claim 1, wherein the report analyzer is to ascertain whether a threshold number of aspects are identified, and when the threshold number of aspects are identified, the report analysis is performed recursively until a predefined set of aspects from among the threshold number of aspects are explained.

7. The system as claimed in claim 1, wherein the report generator is to:
collect data relevant to the report from a data source; and
perform at least one of data model transformation, data cleansing, and data normalization to make the data in the report comparable for report analysis.

8. A method for generating reports comprising:
generating a report, in response to occurrence of a report generation event;
identifying an aspect of the report requiring a description, the aspect being at least one of a trend noted in the report and a discrepancy in the report;
generating a hypothesis explaining the aspect of the report, using at least one of an abductive reasoning, deductive reasoning, and inductive reasoning;
collecting an evidence for the hypothesis, based on a relation between entities of the hypothesis, the relation being determined based on a knowledge data having information pertaining to the entities;
evaluating the hypothesis to generate an evaluation score, based on the collected evidence;
selecting the hypothesis for explaining the aspect, based on the evaluation score;
providing the selected hypothesis in natural language text explaining the aspect of the report, based on at least one of the domain and user knowledge and linguistic knowledge; and
associating the narrative with the aspect of the report.

9. The method as claimed in claim 8, wherein generating the report further comprises determining a type of the report, and wherein the report is generated, based on the determined type.

10. The method as claimed in claim 8, wherein collecting the evidence comprises performing context augmentation of entities and relationship between the entities of the hypothesis.

11. The method as claimed in claim 8, wherein providing the narrative in the natural language text comprises:
generating a text plan for the selected hypothesis, based on the domain and the user knowledge;
generating a sentence plan, based on the text plan, using at least one of the domain and the user knowledge and the linguistic knowledge; and
generating the narrative in the natural language text, based on the sentence plan, using at least one of the domain and the user knowledge and the linguistic knowledge.

12. The method as claimed in claim 8, wherein identifying the aspect comprises implementing a financial statement analysis tool to determine the aspect, the financial statement analysis tool being one of a horizontal analysis tool, a vertical analysis tool, and a ratio analysis tool.

13. The method as claimed in claim 8, wherein the method further comprises ascertaining whether a threshold number of aspects are identified, and when the threshold number of aspects are identified, report analysis, comprising hypothesis generation, is performed recursively until a predefined set of aspects from among the threshold number of aspects are explained.

14. The method as claimed in claim 8, wherein generating the report comprises:
collecting data relevant to the report from a data source; and
performing at least one of data model transformation, data cleansing, and data normalization to make the data in the report comparable for report analysis.

15. A non-transitory computer readable medium including machine readable instructions that are executable by a processor to:
generate a report, in response to occurrence of a report generation event;
identify an aspect of the report requiring a description, the aspect being at least one of a trend noted in the report and a discrepancy in the report;
generate a hypothesis explaining the aspect of the report, using at least one of an abductive reasoning, deductive reasoning, and inductive reasoning;
collect an evidence for the hypothesis, based on a relation between entities of the hypothesis, the relation being determined based on a knowledge data having information pertaining to the entities;
evaluate the hypothesis to generate an evaluation score, based on the collected evidence;
select the hypothesis for explaining the aspect, based on the evaluation score;
provide the selected hypothesis in natural language text explaining the aspect of the report, based on at least one of the domain and user knowledge and linguistic knowledge; and
associate the narrative with the aspect of the report.

16. The non-transitory computer readable medium as claimed in claim 15, wherein to collect the evidence the processor is to perform context augmentation of entities and relationship between the entities of the hypothesis.

17. The non-transitory computer readable medium as claimed in claim 15, wherein the processor is to determine a type of the report, and wherein the report is generated, based on the determined type.

18. The non-transitory computer readable medium as claimed in claim 15, wherein the processor is to:
generate a text plan for the selected hypothesis, based on the domain and the user knowledge;
generate a sentence plan, based on the text plan, using at least one of the domain and the user knowledge and the linguistic knowledge; and
generate the narrative in the natural language text, based on the sentence plan, using at least one of the domain and the user knowledge and the linguistic knowledge.

19. The non-transitory computer readable medium as claimed in claim 15, wherein the processor is to implement a financial statement analysis tool to determine the aspect, the financial statement analysis tool being one of a horizontal analysis tool, a vertical analysis tool, and a ratio analysis tool.

20. The non-transitory computer readable medium as claimed in claim 15, wherein the processor is to ascertain whether a threshold number of aspects are identified, and when the threshold number of aspects are identified, report analysis, comprising hypothesis generation, is performed recursively until a predefined set of aspects from among the threshold number of aspects are explained.
